(19) United States
(12) Patent Application Publication
(10) Pub. No.: US 2023/0064843 A1
(43) Pub. Date: Mar. 2, 2023

(54) WHEEL DRIVING DEVICE

(71) Applicant: KANZAKI KOKYUKOKI MFG. CO., LTD., Amagasaki-shi (JP)

(72) Inventor: Toshiyuki FUKUDA, Amagasaki-shi (JP)

(21) Appl. No.: 17/875,870

(22) Filed: Jul. 28, 2022

(30) Foreign Application Priority Data
Aug. 24, 2021 (JP) 2021-136222

(51) Int. Cl. F16H 48/34

(52) U.S. Cl. CPC F16H 48/34

(57) ABSTRACT

Provided is a wheel driving device in which a lock operation mechanism can be disposed without increasing the width of a housing. In a wheel driving device, the housing includes support walls and a peripheral wall continuous to the support walls, a rotary shaft that rotatably supports a diff-lock fork around the axis orthogonal to the rotation axis of the differential gear is provided at a boundary between the peripheral wall and one of the support walls, the diff-lock fork includes one end portion extending along the support wall and the other end portion extending along the peripheral wall, the one end portion is engaged with a lock slider of the differential gear, and the other end portion is engaged with an actuator installed on the peripheral wall.

### CROSS REFERENCES TO RELATED APPLICATIONS

The present invention claims priority under 35 U.S.C. § 119 to Japanese Application, 2021-136222, filed on Aug. 24, 2021, the entire contents of which being incorporated herein by reference.

### BACKGROUND OF THE INVENTION

### (1) Field of the Invention

At least one example according to the present invention relates to a wheel driving device that transmits power from a power source to a wheel.

Conventionally, for example, as disclosed in JP-A 2001-80385 Gazette, a wheel driving device including a differential gear capable of switching between locking (non-differentiable state) and unlocking (differential state) at the time of driving a wheel in preparation for traveling on rough terrain is known. As a switching mechanism for switching between locking and unlocking of a differential gear, a switching mechanism is known in which an engagement member such as a lock slider is moved by an interlocking member such as a fork, so that the differential gear cannot be operated and right and left wheels can be directly connected (locked) when a wheel spins.

In the related art, an actuator that moves the fork of the switching mechanism is disposed outside a housing in which the differential gear is stored and on the same side as a front wheel drive shaft that is a power input unit in the front-rear direction. The actuator is provided on the wheel side with respect to the front wheel drive shaft in the vehicle width direction (the right-left direction and the direction parallel to the extending direction of the axle). That is, the size of a differential case in the vehicle width direction is increased to secure a place where the actuator is disposed.

In recent years, with an increase in engine horsepower, an engine and each drive transmission component have been increased in size. Therefore, space-saving arrangement of each component is required. In addition, there is a case where a constant velocity joint is disposed between a wheel and an axle extending from the housing of the wheel driving device in the vehicle width direction of the axle, the constant velocity joint being configured to transmit a rotational force by freely changing the angle while maintaining speeds on an input side and an output side. In the constant velocity joint, a predetermined action angle is set in advance to allow the vertical movement of the wheel by the action of a suspension spring, and the width of the housing in the vehicle width direction is desirably set as narrow as possible to secure a space in the width direction for arranging the constant velocity joint. However, according to the related art including the actuator, it is difficult to narrow the width of the wheel driving device.

In addition, in a case where the actuator such as an electromagnetic solenoid type is used as a place where the actuator is installed, it is necessary to consider avoidance of a failure risk such as arranging the actuator at a place away from a high temperature section such as an exhaust pipe or a muffler so as not to cause an operation failure of the actuator due to the influence of heat.

### SUMMARY OF THE INVENTION

At least one example of the present application provides a wheel driving device in which an actuator can be disposed without increasing the width of a housing in the vehicle width direction and the actuator can be disposed at a location where a failure risk is low.

In order to achieve the above, in a wheel driving device being a wheel driving device including a power input unit to which power from a prime mover is input, a differential gear that differentially distributes power from the power input unit to right and left wheels and drives the right and left wheels, and a lock operation mechanism that can lock and unlock the differential gear, the power input unit, the differential gear, and the lock operation mechanism being accommodated in a housing, the housing includes a pair of support walls that rotatably supports a differential case of the differential gear, and a peripheral wall that connects the pair of support walls, a rotary shaft that rotatably supports a diff-lock fork around an axis orthogonal to a rotation axis of the differential gear and is provided at a boundary between the peripheral wall and one of the pair of support walls, an actuator, the diff-lock fork includes one end portion that extends along the one of the pair of support walls and the other end portion that extends along the peripheral wall, the one end portion is engaged with a lock slider of the differential gear, and the another end portion is engaged with the actuator installed on the peripheral wall.

In order to achieve the above, the actuator is provided at a location opposite to the power input unit or in an upper part in the housing of being installed on the vehicle, on the outer surface of the peripheral wall.

In order to achieve the above, the housing includes a support portion capable of supporting the diff-lock fork either in a posture rotatable about a vertical axis or in a posture rotatable about a horizontal axis.

In order to achieve the above, an actuator installation portion may be provided on the peripheral wall of the housing at a section facing the other end portion of the diff-lock fork in the posture rotatable about the vertical axis and at a section facing the other end portion of the diff-lock fork in the posture rotatable about the horizontal axis.

In the wheel driving device having the above-described configuration, the actuator and the diff-lock fork can be provided in the dead space around the support walls and the peripheral wall of the existing housing instead of widening the width in the right-left direction of the housing and accommodating the actuator and the diff-lock fork therein. Therefore, the width in the right-left direction of the housing is the same as that in the specifications without a diff-lock. As a result, even in the specifications with a diff-lock, the length and the angle of the constant velocity joint connecting the differential and the right and left wheels do not change, and the suspension performance of the vehicle is not deteriorated.

In addition, if an exhaust pipe, a muffler, or the like is arranged in the vicinity of the wheel driving device when the wheel driving device is assembled to the vehicle, the solenoid is arranged at a location that is hardly affected by heat from the exhaust pipe, the muffler, or the like. Thus, the solenoid can be arranged at a location with a low failure risk. In a case where common wheel driving devices are commonly mounted for driving both the front wheel and the rear wheel, the solenoid can be arranged by selecting a location having a low failure risk in accordance with the surrounding environment in front of and behind the wheel driving device.

The foregoing or other features and effects will be apparent in the following detailed description of the invention with reference to the accompanying drawings.

### BRIEF DESCRIPTION OF THE DRAWINGS

Hereinafter, some examples will be described with reference to the accompanying drawings, but the examples and the drawings are examples only and are not restrictive. Note that in some drawings, the same elements are denoted by the same reference numerals.

FIG. 1 is a schematic side view illustrating a vehicle equipped with a wheel driving device according to an embodiment of the present invention.

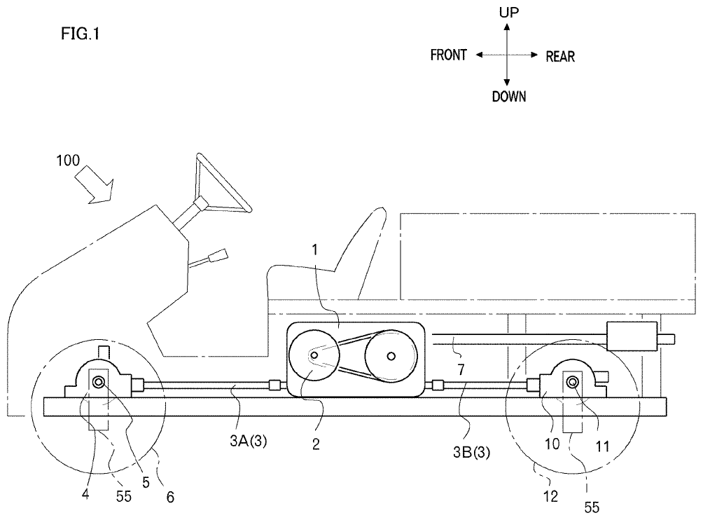

FIG. 2 is a plan cross-sectional view illustrating a rear wheel-side wheel driving device according to an embodiment of the present invention.

FIG. 3 is a cross-sectional view taken along line illustrating the rear wheel-side wheel driving device according to an embodiment of the present invention.

FIG. 4 is a rear perspective view illustrating the rear wheel-side wheel driving device according to an embodiment of the present invention.

FIG. 5 is a cross-sectional view taken along line V-V illustrating the rear wheel-side wheel driving device according to an embodiment of the present invention.

FIG. 6 is a side cross-sectional view illustrating a front wheel-side wheel driving device in which an actuator according to an embodiment of the present invention is disposed in an upper part.

FIG. 7 is a cross-sectional view taken along line VII-VII illustrating the front wheel-side wheel driving device in which the actuator according to an embodiment of the present invention is disposed in the upper part.

### DETAILED DESCRIPTION OF PREFERRED EMBODIMENTS

First, a rough terrain vehicle 100 equipped with a wheel driving device according to an embodiment of the invention will be described. The rough terrain vehicle 100 includes an internal combustion engine 1 as a prime mover, a transmission 2 connected to an output side of the engine 1, drive shafts 3, 3 attached to the output side of the transmission 2 and to which a driving force of the engine 1 is transmitted, a front wheel-side wheel driving device 4 disposed at a front end of the drive shaft 3, a rear wheel-side wheel driving device 10 disposed at a rear end of the drive shaft 3 and including a differential gear 23 therein, a front wheel-side axle 5 connectable to an output of the front wheel-side wheel driving device 4, front wheels 6, 6 connected to the front wheel-side axle 5, a rear wheel-side axle 11 connectable to an output of the rear wheel-side wheel driving device 10, and rear wheels 12, 12 connected to the rear wheel-side axle 11. In addition, the prime mover may be an electric motor instead of engine 1.

The engine 1, which is a prime mover, is provided substantially at the center in the front-rear direction of the rough terrain vehicle 100 and is a device that transmits power to the drive shaft 3 extending in the front-rear direction via the transmission 2. An exhaust pipe 7 thereof extends to the rear side of the vehicle body, and a muffler 7a is installed near the rear end portion. The transmission 2 is a mechanism that changes the speed of the driving force from the engine 1 by an internal speed change gear and a continuously variable transmission mechanism and transmits the changed speed to the drive shafts 3 extending in the front-rear direction.

The drive shafts 3 include a front wheel drive shaft 3A that extends in the forward direction and a shaft 3B for driving rear wheels that extends in the backward direction. The front end of the front wheel drive shaft 3A is connected to the front wheel-side wheel driving device 4. The rear end of the shaft 3B is connected to the rear wheel-side wheel driving device 10.

The front wheel-side wheel driving device 4 is a device that transmits a driving force from the front wheel drive shaft 3A as a power input unit to the front wheel-side axle 5. The rear wheel-side wheel driving device 10 is a device that transmits a driving force from the shaft 3B as a power input unit to the rear wheel-side axle 11.

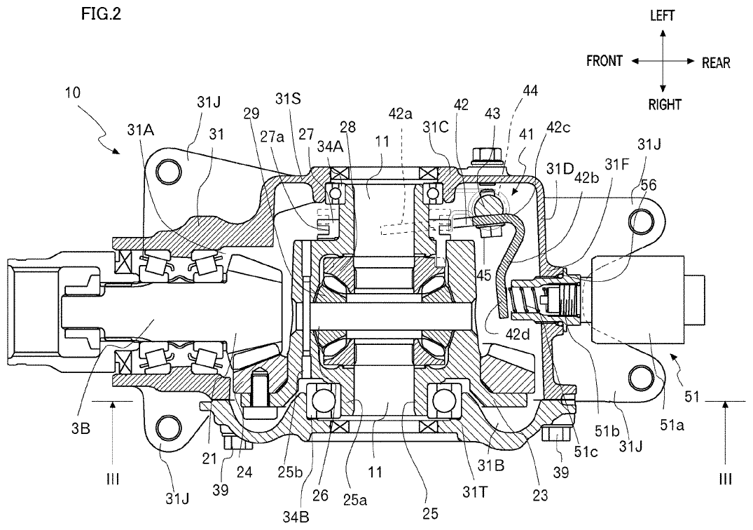

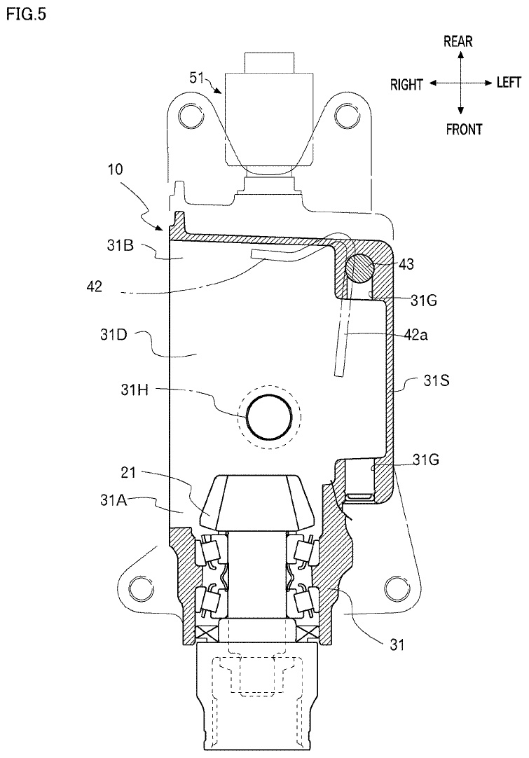

As illustrated in FIGS. 2 to FIG. 5, the rear wheel-side wheel driving device 10 includes a bevel pinion 21 that is a power input unit provided at the rear end of the shaft 3B, and a differential gear 23 that meshes with the bevel pinion 21. The bevel pinion 21 is a bevel gear provided at the rear end of the shaft 3B with the front-rear direction as the rotation axis direction.

The differential gear 23 is a device that differentially distributes power from the shaft 3B to the right and left rear wheels 12, 12 to drive the right and left rear wheels 12, 12, and includes a ring gear 24 meshing with the bevel pinion 21 and a differential case 25 attached to the ring gear 24. In the differential case 25, side gears 28 of a bevel gear type are accommodated. A pinion gear shaft 26 orthogonal to the rotation axis of the side gears 28 is attached to the differential case 25 and revolves together with the ring gear 24 and the differential case 25. The differential gear 23 includes a lock slider 27. The lock slider 27 is configured to be engageable with the side gear 28 pivotally supported by the rear wheel-side axle 11 in the differential case 25. The side gear 28 meshes with pinion gears 29 provided at both ends of the pinion gear shaft 26. The lock slider 27 is slidably fitted to the outside of one of the cylindrical portions 25a provided on both sides of the differential case 25 and is constantly locked to the differential case 25 so as not to be relatively rotatable. By sliding the lock slider 27, the differential case 25 can switch between two states, i.e., a state coupled to the side gear 28 and a state uncoupled from the side gear 28.

Both left and right end portions of the cylindrical portion 25a of the differential case 25 are rotatably supported by bearings 34A, 34B. The bearing 34A and the bearing 34B are provided on support walls 31C of a housing 31, whereby the differential case 25 is rotatably supported by the support walls 31C, 31C. The bearing 34A is smaller than the bearing 34B. With such a configuration, a space on a side where the lock slider 27 is disposed can be secured. The rear wheel-side axle 11, not illustrated, is inserted through each of the right and left cylindrical portions 25a and is spline-fitted to each of the side gears 28.

The shaft 3B and the bevel pinion 21 and the differential gear 23 of the rear wheel-side wheel driving device 10 are stored in the housing 31. The housing 31 has a first chamber 31A for storing the shaft 3B and the bevel pinion 21, and a second chamber 31B for storing the differential gear and the rear wheel-side axle 11. The second chamber 31B includes the support walls 31C that are right and left wall portions and support the rear wheel-side axle 11, and a peripheral wall 31D that connects the right and left support walls 31C and defines the upper and lower surfaces and the rear surface.

Vehicle body frame mounting seats 31J are provided on the front side and the rear side of the housing 31. The housing 31 can be divided into a first member 31S and a second member 31T. The first member 31S is a member constituting one support wall 31C and the peripheral wall 31D, and the second member 31T is a member constituting the other support wall 31C. The first member 31S and the second member 31T are fixed by screws 39. Since the first member 31S and the second member 31T are separated from each other by removing the screws 39, the differential gear 23 and a lock operation mechanism 41 can be disposed inside the second chamber 31B.

The lock operation mechanism 41 operates the differential gear 23 to a locked state or an unlocked state and includes a diff-lock fork 42 that is engaged with a groove 27a provided outside the lock slider 27, and a rotary shaft 43 that rotatably supports the diff-lock fork 42 about an axis orthogonal to a rotation axis of the differential gear 23.

The rotary shaft 43 is supported by a rotary shaft support portion 31E provided at a boundary between the peripheral wall 31D and one support wall 31C. The rotary shaft support portion 31E is a pair of cylindrical holes formed in the vertical direction at a portion where the inner side of the peripheral wall 31D has a thickness. A lock spring 44, which is an elastic member, is wound around the rotary shaft 43. The lock spring 44 is a member that biases the diff-lock fork 42 in one direction. In the present embodiment, a protrusion of the lock slider 27 is biased in a direction in which the protrusion is engaged with a recess in the back surface of the side gear 28. As a result, the differential case 25 and the side gear 28 are engaged when the actuator described later is not operated. Note that in the present embodiment, the lock spring 44 is configured by a helical spring, but is not limited thereto, and may be a leaf spring.

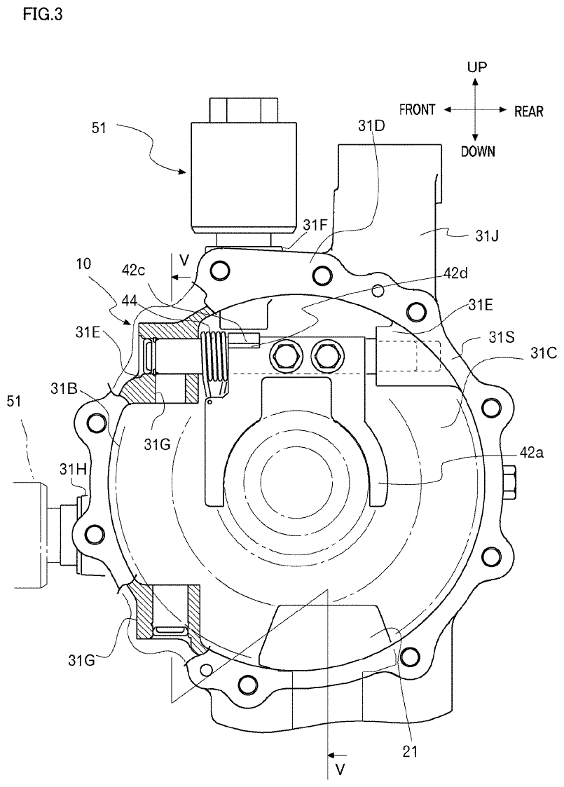

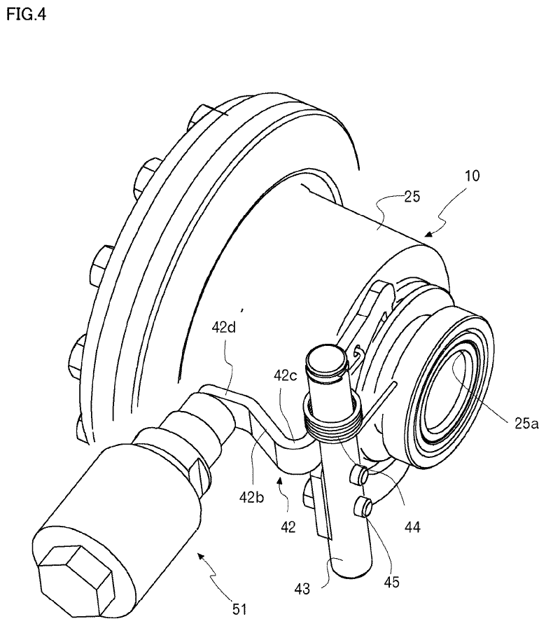

The diff-lock fork 42 has a bifurcated shape in a cross-sectional view and has one end portion 42a extending along the support wall 31C and the other end portion 42b extending along the peripheral wall 31D. The diff-lock fork 42 is fixed to the rotary shaft 43 by a fixing member 45 such as a screw. As illustrated in FIG. 3 and FIG. 4, the one end portion 42a extending along the support wall 31C is fitted into an annular groove 27a provided in the outer periphery of the lock slider 27. The other end portion 42b extending along the peripheral wall 31D includes a relay portion 42c once extending inward of the housing and a pressed portion 42d that is folded back and extends in parallel along the peripheral wall 31D to be pressed by an actuator 51 in plan view.

The actuator 51 is installed on the outer surface of the peripheral wall 31D. The actuator 51 includes a push-pull electromagnetic solenoid and is electrically controlled. The actuator 51 includes a main body portion 51a and a pressing portion 51b slidable relative to the main body portion 51a. When the pressing portion 51b presses the pressed portion 42d of the diff-lock fork 42, the diff-lock fork 42 turns about the rotary shaft 43.

An opening with a female screw is provided at a predetermined location in the peripheral wall 31D, and an actuator installation portion 31F that has a cylindrical shape is screwed therein. The actuator installation portion 31F is provided at a section facing the other end portion 42b of the diff-lock fork 42 in a posture rotatable about the vertical axis and is provided on the rear surface side of the peripheral wall 31D in the case of the present example. In the actuator installation portion 31F, the pressing portion 51b is movably accommodated toward the diff-lock fork 42. A seal member 56 is provided at a contact portion between a flange portion of the actuator installation portion 31F and the outer surface of the peripheral wall 31D.

A compression coil spring 51c is interposed between the pressing portion 51b of the actuator 51 and the diff-lock fork 42. When the actuator 51 is not operated and the electromagnetic solenoid is de-energized, the state of FIG. 2 is obtained. That is, under the action of the lock spring 44, the diff-lock fork 42 swings in the direction of locking the differential while compressing the spring 51c, and the protrusion of the lock slider 27 is fitted into the recess of the side gear 28. Note that in a case where the protrusion of the lock slider 27 cannot be fitted into the recess of the side gear 28, the compressed state of the lock spring 44 continues with respect to the diff-lock fork 42 that cannot be swung, and the swing power of the diff-lock fork 42 is maintained until the recess and the protrusion are fitted.

Next, an unlocked state in which the actuator 51 is operated to bring the lock slider 27 into the non-engagement state during normal traveling such as traveling on a paved road surface will be described.

When the push-pull type electromagnetic solenoid is energized, a pin, not illustrated, protrudes, and when the urging force of the lock spring 44 is exceeded via the pressing portion 51b and the spring 51c, the pressed portion 42d of the diff-lock fork 42 is pressed forward. When the pressed portion 42d moves forward, the diff-lock fork 42 moves about the rotary shaft 43, and the one end portion 42a moves the lock slider 27 in the direction in which the lock slider 27 is brought into the disengaged state.

Therefore, the engagement between the differential case 25 and the side gear 28 is released, and as normally, in the differential gear 23, each of the right and left side gears 28 rotates differentially according to the load from the ground acting on each of them.

In the rear wheel-side wheel driving device 10 according to the present example, the main body portion 51a of the actuator 51 is disposed so as to protrude rearward of the housing 31. That is, the main body portion 51a of the actuator 51 is attached to the peripheral wall 31D on the rear side of the housing 31 and is disposed at a location facing the place where the shaft 3B located forward is disposed. As a result, as illustrated in FIG. 2, the actuator 51 can be disposed without widening the peripheral wall 31D in the width direction in the right-left direction.

By disposing the actuator 51 behind the housing 31, it is possible to dispose the actuator 51 at a location away from the engine 1 provided in the intermediate portion of the rough terrain vehicle 100, the exhaust pipe 7 extending rearward from the engine 1 and the muffler 7a.

A wheel driving device having a configuration similar to that of the rear wheel-side wheel driving device 10 can also be used as the front wheel-side wheel driving device 4. In this case, since an actuator is located on the opposite side of the front wheel drive shaft 3A, the actuator protrudes forward. If there is a concern that the actuator in such a state may interfere with the steering mechanism, another vehicle-side device, or various device components, or there is a concern about failure due to collision with a front obstacle, it is also possible to take the following measures.

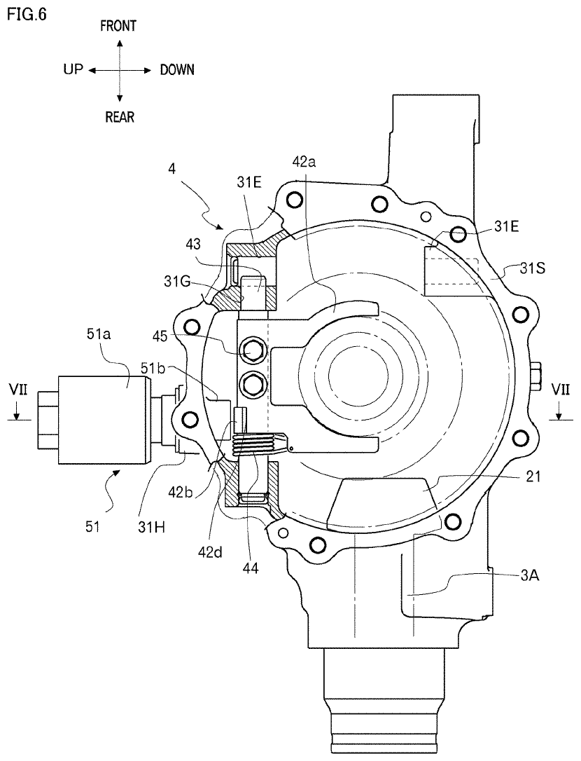

That is, as illustrated in FIG. 6, in a case where the lock operation mechanism 41 is provided in the front wheel-side wheel driving device 4, a rotary shaft 43 of a lock operation mechanism 41 is disposed in a direction orthogonal to the rotation axis of a differential gear 23 and in the front-rear direction when the front wheel-side wheel driving device 4 is mounted on the vehicle.

The rotary shaft 43 of the lock operation mechanism 41 is supported by front and rear surfaces, which are a peripheral wall 31D, of a housing 31. A rotary shaft support portion 31G is provided at a boundary between the peripheral wall 31D and one support wall 31C. The rotary shaft support portion 31G is a pair of cylindrical holes formed in the horizontal direction at a portion where the inner side of the peripheral wall has a thickness.

Since a diff-lock fork 42 has a configuration similar to that described in the rear wheel-side wheel driving device 10, detailed description thereof will be omitted.

Since the actuator 51 installed on the peripheral wall 31D has a configuration similar to that described in the rear wheel-side wheel driving device 10, detailed description thereof will be omitted.

An actuator installation portion 31H provided on the peripheral wall 31D is provided at a section facing the other end portion 42b of the diff-lock fork 42 in a posture rotatable about the horizontal axis and is provided on the upper surface side of the peripheral wall 31D. Since the actuator installation portion 31H has a configuration similar to that described in the rear wheel-side wheel driving device 10, detailed description thereof will be omitted.

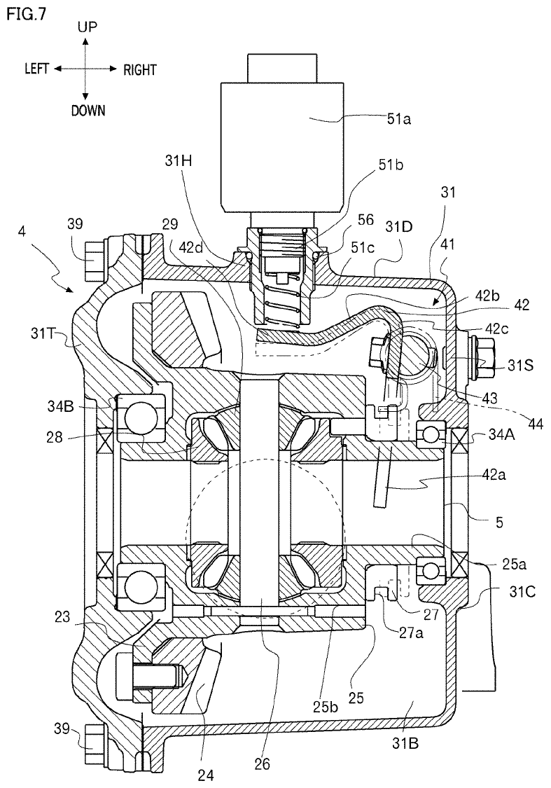

A main body portion 51a of the actuator 51 is disposed so as to protrude above the housing 31. That is, the main body portion 51a of the actuator 51 is attached to the upper peripheral wall 31D of the housing 31. As a result, as illustrated in FIG. 7, the actuator 51 can be disposed without widening the peripheral wall 31D in the width direction in the right-left direction. As a result, even in the specifications with a diff-lock, the length and the angle of the front wheel-side axle 5 connecting the differential gear 23 and the right and left front wheels 6, 6 do not change, and the suspension performance of the rough terrain vehicle 100 is not deteriorated.

When the front wheel-side wheel driving device 4 is provided with the lock operation mechanism 41, the actuator 51 is disposed above the housing 31, so that the failure risk of the electromagnetic solenoid due to contact with an obstacle located in front of the rough terrain vehicle 100 can be reduced. That is, the failure risk of the electromagnetic solenoid can be reduced by reducing the contact probability with an obstacle as compared with the case where the electromagnetic solenoid is disposed at a location protruding forward. Alternatively, in a case where various device components of the vehicle such as a steering mechanism are located immediately ahead of the front wheel-side wheel driving device 4, interference with them can be avoided.

Next, a lock slider 27 is brought into the unlocked state/locked state by the actuation/non-actuation of the actuator 51; however, description thereof is omitted since the description is the same as that of the rear wheel-side wheel driving device described above.

As described above, in the wheel driving device 4, 10 according to the present invention being the wheel driving device 4, 10 including the bevel pinion 21 that is a power input unit to which power from the engine 1, which is a prime mover, is input, the differential gear 23 that differentially distributes power from the bevel pinion 21 to the right and left rear wheels 12, 12 and drives the right and left rear wheels 12, 12, and the lock operation mechanism 41 that can lock and unlock the differential gear 23, the bevel pinion 21, the differential gear 23, and the lock operation mechanism 41 being accommodated in the housing 31, the housing 31 includes the pair of support walls 31C that rotatably supports the differential case 25 of the differential gear 23, and the peripheral wall 31D that connects the pair of support walls 31C, the rotary shaft 43 that rotatably supports the diff-lock fork 42 around the axis orthogonal to the rotation axis of the differential gear 23 is provided at a boundary between the peripheral wall 31D and one of the pair of support walls 31C, the diff-lock fork 42 includes the one end portion 42a that extends along the one of the pair of support walls 31C and the other end portion 42b that extends along the peripheral wall 31D, the one end portion 42a is engaged with the lock slider 27 of the differential gear 23, and the other end portion 42b is engaged with the actuator 51 installed on the peripheral wall 31D.

With such a configuration, the actuator 51 and the diff-lock fork 42 can be provided in the space around the support walls 31C and the peripheral wall 31D of the existing housing 31 instead of widening the width in the right-left direction of the housing 31. Therefore, the width in the right-left direction of the housing 31 is the same as that in the specifications without a diff-lock. As a result, even in the specifications with a diff-lock, the length and the angle of the rear wheel-side axle 11 connecting the differential gear 23 and the right and left rear wheels 12, 12 do not change, and the suspension performance of the rough terrain vehicle 100 is not deteriorated.

In addition, the actuator 51 may be an electromagnetic solenoid, and may be provided at a location opposite to the bevel pinion 21 or in an upper part in the case of being mounted on the rough terrain vehicle 100, on the outer surface of the peripheral wall 31D.

With such a configuration, when the wheel driving device 10 is mounted on the rough terrain vehicle 100 as the wheel driving device for the rear wheels, in a case where the exhaust pipe 7 and the muffler of the engine 1 pass over the upper surface of the wheel driving device 10, the electromagnetic solenoid can be disposed away from the high heat portion, or when the wheel driving device 10 is mounted as the wheel driving device for the front wheels, the failure risk of the electromagnetic solenoid due to contact with an obstacle located in front of the rough terrain vehicle 100 can be reduced.

The housing 31 may include the rotary shaft support portion 31E and the rotary shaft support portion 31G capable of supporting the diff-lock fork 42 in a posture rotatable about the vertical axis and in a posture rotatable about the horizontal axis, respectively.

With such a configuration, since the common housing 31 is used and the rotary shaft support portion 31E and the rotary shaft support portion 31G which each can support the diff-lock fork 42 in a certain manner are provided, it is possible to choose a location where the diff-lock fork 42 is to be installed. By using the common wheel driving devices 4, 10 for the front and rear wheels, the manufacturing cost can be reduced, and it is possible to choose the position of the actuator with a lower failure risk in accordance with the surrounding environment when the front and rear wheel driving devices are mounted.

Furthermore, the actuator installation portion 31F and the actuator installation portion 31H may be provided on the peripheral wall 31D of the housing 31 at a section facing the other end portion 42b of the diff-lock fork 42 in the posture rotatable about the vertical axis and at a section facing the other end portion 42b of the diff-lock fork 42 in the posture rotatable about the horizontal axis.

With such a configuration, actuation of actuator 51 causes other end portion 42b of the diff-lock fork 42 to swing, thereby allowing the lock slider 27 engaged with the one end portion 42a of the diff-lock fork 42 to slide.

The above description relates to specific examples according to the present invention, and various modifications are possible without departing from the spirit of the present invention. The appended claims are intended to cover such applications within the true scope and spirit of the present invention.

Therefore, all the examples disclosed in the present application should be considered as illustrative and should not be considered as restrictive. The scope of the present invention is indicated in the following claims rather than in the above specification, and any modification that falls within the scope equivalent to the meaning of the claims should be included in the scope of the present invention.

What is claimed is:

1. A wheel driving device comprising:
a power input unit to which power from a prime mover is input;
a differential gear that differentially distributes power from the power input unit to right and left wheels and drives the right and left wheels; and
a lock operation mechanism that can lock and unlock the differential gear, the power input unit, the differential gear, and the lock operation mechanism being accommodated in a housing,
the housing including
a pair of support walls that rotatably supports a differential case of the differential gear, and
a peripheral wall that connects the pair of support walls,
the wheel driving device further comprising
a rotary shaft that rotatably supports a diff-lock fork around an axis orthogonal to a rotation axis of the differential gear and is provided at a boundary between the peripheral wall and one of the pair of support walls,
an actuator,
the diff-lock fork including one end portion that extends along the one of the pair of support walls and another end portion that extends along the peripheral wall,
the one end portion being engaged with a lock slider of the differential gear, and
the another end portion being engaged with the actuator installed on the peripheral wall.

2. The wheel driving device according to claim 1, wherein the actuator is provided at a location opposite to the power input unit or in an upper part in the housing of being installed on a vehicle, on an outer surface of the peripheral wall.

3. The wheel driving device according to claim 1, wherein the housing includes a support portion capable of supporting the diff-lock fork either in a posture rotatable about a vertical axis or in a posture rotatable about a horizontal axis.

4. The wheel driving device according to claim 2, wherein the housing includes a support portion capable of supporting the diff-lock fork either in a posture rotatable about a vertical axis or in a posture rotatable about a horizontal axis.

5. The wheel driving device according to claim 3, wherein an actuator installation portion is provided on the peripheral wall of the housing at a section facing the other end portion of the diff-lock fork in the posture rotatable about the vertical axis and at a section facing the other end portion of the diff-lock fork in the posture rotatable about the horizontal axis.

6. The wheel driving device according to claim 4, wherein an actuator installation portion is provided on the peripheral wall of the housing at a section facing the other end portion of the diff-lock fork in the posture rotatable about the vertical axis and at a section facing the other end portion of the diff-lock fork in the posture rotatable about the horizontal axis.
